(19) United States
(12) Patent Application Publication
(10) Pub. No.: US 2009/0121057 A1
(43) Pub. Date: May 14, 2009

(54) Multi-Functional Office Equipment

(76) Inventor: Edward L. Brown, SR., Vineland, NJ (US)

Correspondence Address: ADVANTIA LAW GROUP, 9035 SOUTH 1300 EAST, SUITE 200, SANDY, UT, 84094, US

(21) Appl. No.: 11/940,021

(22) Filed: Nov. 14, 2007

(51) Int. Cl. B02C 18/06; G06K 15/00

(52) U.S. Cl. 241/62; 358/401; 358/442; 241/203

(57) ABSTRACT

An office device. The device includes: a paper shredder, an ink dispensing device, a housing, a display device, a user interface, a control module, a combination device, an entry slot, a transparent member, and a bin. The ink dispensing device disperses ink over paper shredded by the paper shredder. The display device is hingedly coupled to the housing. The user interface is slidably coupled to the housing. The control module communicates with the display device and user interface. The combination device includes a copier device, a fax device, and laser printer device. The entry slot permits paper to be fed thereto. The transparent member covers a portion of the entry slot. The bin is disposed within the housing. The display device is a monitor. The user interface is a keyboard. The paper shredder includes a rotating vertical shredder and a rotating diagonal shredder.

### BACKGROUND OF THE INVENTION

1. Field of the Invention

The present invention relates to office devices, specifically a multi-functional office device.

2. Description of the Related Art

Multi-functional office machines or the like have been employed so that people working in the administrative and office management professions may perform administrative type functions such as printing documents; faxing documents from one location to another; scanning documents; etc. In addition, there is an increasing trend for people to employ such machines at their private residences to perform administrative/office functions relating to their home-based businesses or employment. Besides having the capability to print, fax, and scan documents, what is needed is an office machine or device with the capability to shred important or confidential documents without fear of an authorized individual gaining access to such documents and stealing ones identity or important personnel information, particularly those documents protected by the Privacy Act of 1974. Some improvements have been made in the field. Examples include but are not limited to the references described below, which references are incorporated by reference herein:

U.S. Pat. No. 6,825,946, issued to Motoyama, discloses a multi-function machine for combining and routing image data is disclosed. The multi-function machine includes a number of functional units, for instance, a digital copier which produces scanned image data, a printer which prints image data from a computer, and a facsimile device which receives and sends facsimile image data. Image data from one or a number of sources may be combined to form merged image data, corresponding to a merger of the individual images. The merged image data may then be conveyed to any of a number of user selectable destinations, including a printer, a host computer, or a facsimile device.

U.S. Pat. No. 6,806,977, issued to Freeny et al., discloses a multiple integrated machine system (hereafter referred to as “MIMS”) capable of performing as at least two or more digital machines. The MIMS comprises two or more digital machine elements controlled by the same operating system software. Each of the digital machine elements includes hardware portions and software portions and each digital machine element is capable of performing as part of one of the digital machines. Each of the digital machine elements is different. A digital machine element grouping control unit is also provided. The digital machine element grouping control unit automatically and operatively connects predetermined digital machine elements in a first combination to form a first digital machine upon receipt of a first digital machine selection, and automatically and operatively connects predetermined digital machine elements in a second combination to form a second digital machine upon receipt of a second digital machine selection.

U.S. Pat. No. 6,781,823, issued to Nyack, discloses a Complete Office Portable computers combine eighteen unique additional features/devices/machines into one personal computer unit in order to make access, and relocation of equipment simplified. The combination of the machines incorporated into The Complete Office Portable Computers create a new frontier in the art by providing the ability to interface with wireless technologies and perform more task/functions than other state of the art personal computer units presently on the market or that which is considered as old in the art. The Complete Office Portables open up new avenues of communications and E commerce transacting for PC users as well. The combination and additions comprise of 1 Digital Cameras, 2 Magnetic Card Slides, 3 Telephones, 4 Voice/memo Recorders, 5 Speakerphones, 6 Condenser Microphones, 7 AM/FM Radio's with 120 watt base booster speakers, 8 Paper Trays, 9 Printers, 10 Fax Machines, 11 Copy Machine, 12 Scanning Device, 13 Paper Shredding Device, 14 Hidden Featured, 15 Internal Illuminating Device's, 16 Removable Monitors, 17 Removable Keyboards, and 18 Easy portability of all the above stated in this abstract of the invention; makes The Complete Office Portable Computer units unique and a big improvement and new to the art.

U.S. Pat. No. 5,666,191, issued to Hasegawa et al., discloses a device for obliterating printed information on a sheet utilizes an information concealing printing unit for printing an information concealing pattern over a surface of a sheet carrying printed information. On printing the information concealing pattern over the surface of the sheet carrying the printed information, the printed information becomes unreadable. Various types of printing devices may be used and the printed information which is obliterated may be first recorded in electronic format for later retrieval.

U.S. Pat. No. 4,573,409, issued to Clar et al., discloses a method of rendering subject matter which is printed on one surface of a computer paper sheet unintelligible, an alpha-numeric interference pattern is printed over substantially the entire printing area of the surface of the sheet carrying the printed subject matter, the density of the interference pattern being sufficient to render the printed subject matter unintelligible. One particular use of the method is in the overprinting of computer print-out paper having printed information on one surface, so that the paper may be reused by printing on its opposite surface without permitting access to the information on the first-printed surface. A machine is disclosed for this application of the method.

U.S. Design Pat. No. 331,050, issued to Massey, discloses an ornamental design for a combined facsimile and copy machine.

The inventions heretofore known suffer from a number of disadvantages which include: being inconvenient to use; being limited in functionality; and/or lacking a capability to shred documents.

What is needed is an office device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available office devices. Accordingly, the present invention has been developed to provide a multi-functional office device.

There is one embodiment of a multi-functional office that may include: a paper shredder; an ink dispensing device that may be coupled to the paper shredder, whereby ink may be dispensed over paper shredded by the paper shredder; a housing; a display device that may be hingedly coupled to the housing; a user interface that may be slidably coupled to the housing; a control module in communication with the display device and the user interface; a combination device that may include: a copier device, a fax device, and/or laser printer device that may be disposed within the housing; an entry slot that may be in communication with the combination device and/or configured to permit paper to be fed thereto; a transparent member that may cover a portion of the entry slot; and/or a bin that may be disposed within the housing and/or accessible from outside the housing,

According to one embodiment of the invention, the paper shredder and/or the ink dispensing device may be disposed within the housing.

According to another embodiment of the invention, the display device may be a monitor and/or the user interface may be a keyboard.

In yet another embodiment of the invention, the ink dispensing device may be disposed in relation to the shredder such that paper fed to the shredder is may be first placed in contact with ink from the ink dispensing device and/or then secondly may be shredded.

In still yet another embodiment of the invention, the paper shredder may include a rotating vertical shredder and/or a rotating diagonal shredder.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s), in which:

FIG. 1 illustrates a perspective view of a multi-functional office device, according to one embodiment of the invention;

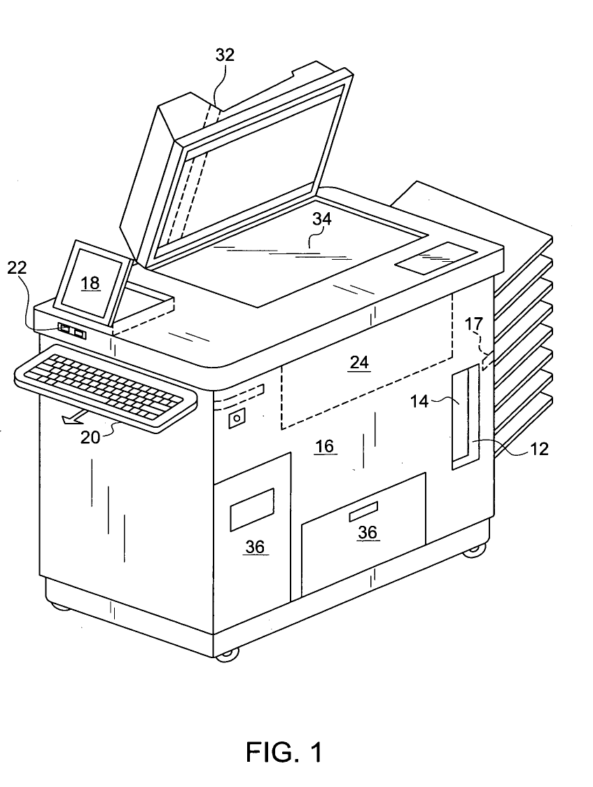

FIG. 2 illustrates a front elevational view of a multi-functional office device, according to one embodiment of the invention; and

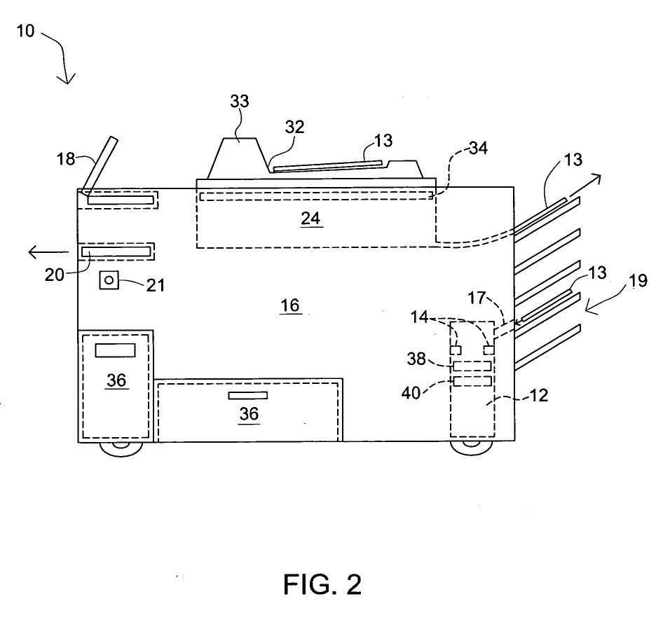

FIG. 3 illustrates a block diagram of a multi-functional office device, according to one embodiment of the invention.

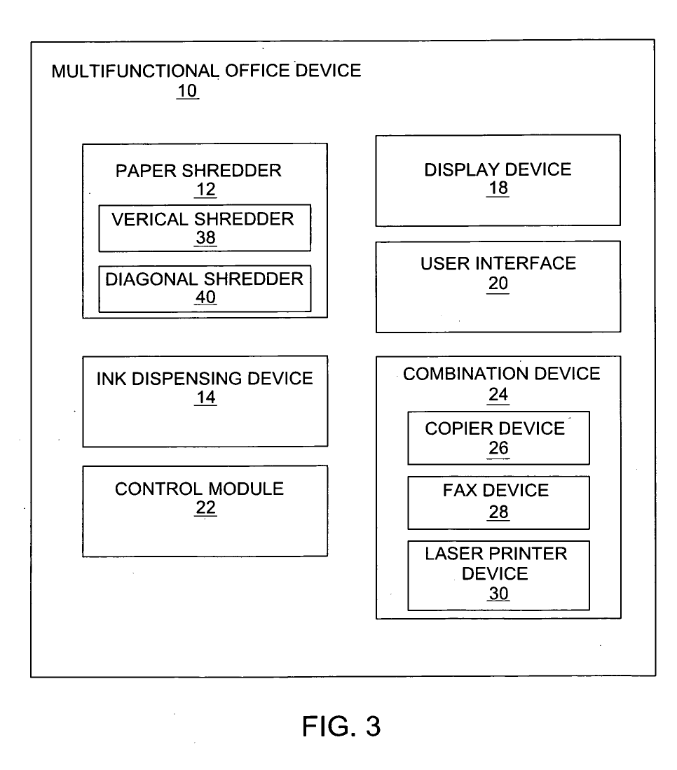

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Looking to the drawing figures, there is one embodiment of a multi-functional office 10 includes: a paper shredder 12 such as a Fellowes PS60C-2 Confetti Paper Shredder, Fellowes, Inc., 1789 Norwood Avenue, Itasca, Ill. 60143 configured to shred a piece of paper 13 into pieces; an ink dispensing device 14, and mechanically coupled to the paper shredder 12 disposed within a housing 16. One example of an ink dispensing device may be but not limited to a ink dispensing device as described in U.S. Pat. No. 6,409,327, issued to Koeleman et al. which is incorporated for its supported teachings herein. The ink dispensing device 14 is disposed in relation to the shredder 12 and may include a motion sensor in signal communication with the shredder 12, such that paper 13 fed to the shredder 12 is first placed in contact with ink dispensed from the ink dispensing device 14 and then is secondly shredded. According to one embodiment of the invention, the ink dispensing device is configured to dispense ink over the paper 13 until such is substantially saturated with ink, thereby concealing any original information printed on the paper 13.

In another embodiment of the invention, the non-limiting example of the paper shredder 12, described in paragraph 32, may be modified to include a rotating vertical shredder 38 having vertically oriented blades configured to vertically shred the ink-saturated paper into vertical strips and a rotating diagonal shredder 40 having blades oriented at an angle to the rotating vertical shredder blades, thereby enabling the ink-saturated paper to be shredded. The ink saturated shredded paper 13 would make it nearly impossible for an unauthorized individual to piece the shredded paper 13 together, like a puzzle, to gain access sensitive or privileged information pertaining to personnel, business, etc., as well as commit identity theft.

In yet another embodiment of the invention, the device 10 further includes: a display device 18 such as a Dell Ultra Sharp 2407WFP 24-inch Wide-Screen Flat Panel Monitor, Dell Corporation, One Dell Way, Round Rock, Tex. 78682, hingedly coupled to the housing 16; a user interface 20, such as a Dell Computer Keyboard, slidably coupled to the housing 16; a control module 22 such as a push button switch manufactured by Honeywell Sensing and Controls, Inc., 11 West Spring Street, Freeport, Ill. 61032, in electrical communication with the display device 18 and the user interface 20, and configured to actuate the display device 18; and a non-limiting example of a combination device 24 such as a Phaser™ 6110MFP, Xerox Corporation, 800 Phillips Road, Webster, N.Y. 14580 having: a copier device 26, a fax device 28, and a laser printer device 30 disposed within the housing 16, and configured to enable a user to perform multi-office functions such as copying documents, faxing documents, printing documents, etc.

In still yet another embodiment of the invention, the device further includes: an entry slot 32 in mechanical communication with the combination device 24 and is configured to permit paper 13 to be fed thereto; a transparent member 34, such as glass or the like, configured to cover a portion of the entry slot 32 as a means to protect a user from exposure to radiation while copying documents; and a bin 36 such as a storage space, disposed within the housing and is accessible from outside the housing 16, and configured to receive and store office stationary such as clean printer paper, recyclable paper, etc.

In still yet a further embodiment of the invention, the device 10 includes a writing utensil sharper 21 disposed on the housing 16, and configured for a user to conveniently sharpen writing utensils such as conventional pencils, colored pencils, etc.

In operation of the illustrated embodiment, a user may manipulate the control module 22 to activate the display device 10 and user interface 20, thereby enabling the user employ the user interface 20 to deliver computer software commands to the combination device 24 to perform multi-office functions such as copying documents; fax documents, laser printing documents, and shredding papers 13. A user desiring to shred papers to protect sensitive information may feed the paper through a slot 17, wherein the ink dispensing device 14 may dispense ink on the paper 13 while the shredders 12, 38, 40 vertically and diagonally shred the paper 13 into strips. In other embodiments, the user may shred a plurality of ink-saturated papers.

Embodiments of the multi-functional office device 10 conveniently performs a wide variety of office functions such as: sharpening writing utensils, shredding paper, copying documents, faxing documents, etc. Additionally, employing the device 10 also eliminates the need to purchase separate pieces of office equipment such as printers, computer monitors, shredders, keyboards, etc. Moreover, the device offers easy accessibility to a multitude of office equipment at a single location in a given building.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

It is envisioned that the ink dispensing device 14 may dispense various colors of ink onto paper being shredded by the paper shredder 12, as desired, according to alternative embodiments. For example, black, blue, red, etc.

It is also envisioned that the paper shredder 12; ink dispensing device 14; display device 18; a user interface 20; control module 22; combination device 24; copier device 26, fax device 28; laser printer device 30; entry slot 32; transparent member 34; bin 36; rotating vertical shredder 38 and/or rotating diagonal shredder may be disposed anywhere on the exterior and/or interior of the office device housing 16.

It is expected that there could be numerous variations of the design of this invention. An example is that the paper shredder 12; ink dispensing device 14; housing 16; display device 18; a user interface 20; control module 22; combination device 24; copier device 26, fax device 28; laser printer device 30; entry slot 32; transparent member 34; bin 36; rotating vertical shredder 38 and/or rotating diagonal shredder 40 may vary in length, width, size, structure, thickness, shape, design, color, etc., according to various embodiments of the invention.

Finally, it is envisioned that the components of the device may be constructed of a variety of materials, such as plastic, composite material, polymer, glass, metal, metal alloys, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An multi-functional office device, comprising:
a paper shredder;
an ink dispensing device coupled to the paper shredder, whereby ink is dispensed over paper shredded by the paper shredder.

2. The multi-functional office device of claim 1, further comprising:
a housing;
a display device hingedly coupled to the housing;
a user interface slidably coupled to the housing;
a control module in communication with the display device and the user interface;
a combination device including a copier device, a fax device, and laser printer device disposed within the housing;
an entry slot in communication with the combination device and configured to permit paper to be fed thereto;
a transparent member covering a portion of the entry slot;
a bin disposed within the housing and accessible from outside the housing; and
wherein the paper shredder and the ink dispensing device are disposed within the housing.

3. The multifunctional office device of claim 1, wherein the display device is a monitor and the user interface is a keyboard.

4. The multifunctional office device of claim 1, wherein the ink dispensing device is disposed in relation to the shredder such that paper fed to the shredder is first placed in contact with ink from the ink dispensing device and then second shredded.

5. The multifunctional office device of claim 1, wherein the paper shredder includes a rotating vertical shredder and a rotating diagonal shredder.

6. An office device, consisting essentially of:
a housing;
a display device hingedly coupled to the housing;
a user interface slidably coupled to the housing;
a control module in communication with the display device and the user interface;
a combination device including a copier device, a fax device, and laser printer device disposed within the housing;
an entry slot in communication with the combination device and configured to permit paper to be fed thereto;
a transparent member covering a portion of the entry slot;
a bin disposed within the housing and accessible from outside the housing;
a paper shredder disposed within the housing; and
an ink dispensing device coupled to the paper shredder and disposed within the housing.

7. The multifunctional office device of claim 6, wherein the display device is a monitor and the user interface is a keyboard.

8. The multifunctional office device of claim 7, wherein the ink dispensing device is disposed in relation to the shredder such that paper fed to the shredder is first placed in contact with ink from the ink dispensing device and then second shredded.

9. The multifunctional office device of claim 8, wherein the paper shredder includes a rotating vertical shredder and a rotating diagonal shredder.
